(19) United States
(12) Patent Application Publication
(10) Pub. No.: US 2022/0049906 A1
(43) Pub. Date: Feb. 17, 2022

(54) HEAT PIPES INCLUDING COMPOSITE WICKING STRUCTURES, AND ASSOCIATED METHODS OF MANUFACTURE

(71) Applicant: NuScale Power, LLC, Portland, OR (US)

(72) Inventors: Derick Botha, Corvallis, OR (US); Michele Walden, Albany, OR (US)

(21) Appl. No.: 17/404,540

(22) Filed: Aug. 17, 2021

Related U.S. Application Data
(60) Provisional application No. 63/066,515, filed on Aug. 17, 2020.

(51) Int. Cl. F28D 15/04; F28F 21/04; F28F 21/08; G21C 15/257; B22F 10/28; B28B 1/00; B33Y 10/00; B33Y 80/00

(52) U.S. Cl. CPC F28D 15/046; F28F 21/04; F28F 21/08; G21C 15/257; F28F 2255/00; B28B 1/001; B33Y 10/00; B33Y 80/00; B22F 10/28

(57) ABSTRACT

Heat pipes and methods of forming heat pipes, such as for use in nuclear reactor systems, are described herein. A representative method of forming a heat pipe includes forming a first wicking structure from a first material and forming a second wicking structure on the first wicking structure. Forming the second wicking structure can include mixing a second material and a third material, and heating the mixture of the second material and the third material to a temperature (a) less than a melting temperature of the second material and (b) greater than a melting temperature of the third material to melt the third material. The method can further include cooling the mixture of the second material and the third material to below the melting temperature of the third material such that the third material solidifies to bond together a plurality of particles of the second material into a porous structure.

### CROSS-REFERENCE TO RELATED APPLICATION

This application claims the benefit of U.S. Provisional Patent Application No. 63/066,515, filed Aug. 17, 2020, and titled “MATERIAL COMPOSITION TO ENABLE THREE-DIMENSIONAL (3D) PRINTING OF A COMPOSITE HEAT PIPE WICK,” which is incorporated herein by reference in its entirety.

### TECHNICAL FIELD

The present technology is related to methods and devices for forming heat pipes and heat pipe components, such as composite wicks, for use in power conversion systems, such as nuclear reactor power conversion systems.

### BACKGROUND

Heat pipes are heat-transfer devices that combine the principles of both thermal conductivity and phase transition to effectively transfer heat between two interfaces. More specifically, heat pipes are closed vessels that house a working fluid and include an evaporator region positioned at a hot interface and a condenser region positioned at a cool interface. The hot interface heats and evaporates/vaporizes the working fluid in the evaporator region. A pressure differential between the hot evaporator region and the cooler condenser region causes the evaporated/vaporized working fluid to flow through the heat pipe from the evaporator region toward the condenser region, where the working fluid cools and condenses, releasing latent heat to the cool interface. The condensed/cooled working fluid is then transported back to the evaporator region via capillary action, centrifugal force, gravity, and/or other forces acting against the pressure differential. For example, heat pipes can include a wick for transporting the working fluid via capillary action.

Due to the very high heat transfer coefficients for evaporation and condensation, heat pipes are highly effective thermal conductors. Accordingly, heat pipes can be used to remove heat in power plants, such as from a core of a nuclear reactor. Heat pipes can also be used to remove/transport heat in spacecraft, computer systems, and other applications where very effective heat transfer is desirable.

### BRIEF DESCRIPTION OF THE DRAWINGS

Many aspects of the present technology can be better understood with reference to the following drawings. The components in the drawings are not necessarily to scale. Instead, emphasis is placed on clearly illustrating the principles of the present technology.

FIGS. 1A and 1B are a longitudinal cross-sectional view and a transverse cross-sectional isometric view, respectively, of a heat pipe configured in accordance with embodiments of the present technology.

FIG. 2 is an enlarged cross-sectional view of an interface between a portion of a first wick of the heat pipe of FIGS. 1A and 1B and a portion of a second wick of the heat pipe of FIGS. 1A and 1B in accordance with embodiments of the present technology.

FIGS. 3A-3C are transverse cross-sectional views of the heat pipe of FIGS. 1A and 1B illustrating various stages in a method of manufacturing the heat pipe in accordance with embodiments of the present technology.

FIGS. 4A and 4B are cross-sectional side views of an additive manufacturing system that can be used in the method of forming the heat pipe shown in FIGS. 3A-3C in accordance with embodiments of the present technology.

FIG. 5 is a partially schematic side cross-sectional view of a nuclear reactor system including a plurality of the heat pipes of FIGS. 1A and 1B in accordance with embodiments of the present technology.

### DETAILED DESCRIPTION

Aspects of the present disclosure are directed generally toward heat pipes and methods of manufacturing heat pipes, such as for use in nuclear reactor systems. In several of the embodiments described below, a representative method of manufacturing a heat pipe includes forming a first wicking structure from a first material and forming a second wicking structure on the first wicking structure. The first and second wicking structures can together form a monolithic structure. Forming the second wicking structure can include mixing a second material and a third material, and heating the mixture of the second material and the third material to a temperature that is (i) less than a melting temperature of the second material and (b) greater than a melting temperature of the third material to melt the third material. The method can further include cooling the mixture of the second material and the third material to below the melting temperature of the third material such that the third material solidifies to bond together a plurality of particles of the second material into a porous structure.

In some embodiments, forming the first and second wicking structures can include forming the wicking structures via one or more three-dimensional (3D) additive manufacturing processes such as, for example, one or more laser directed energy deposition (DED) additive manufacturing processes. For example, forming the first wicking structure can include directing a laser against a metal wire of the first material to melt the first material. Similarly, forming the second wicking structure can include directing a laser against a mixture of a powder of the second material and a powder of the first material to melt the third material without melting the second material, thereby allowing the second material to mix with the melted third material. In some embodiments, the first and third materials can be metallic materials (e.g., including molybdenum) and the second material can be a non-metallic material (e.g., a ceramic material).

In some embodiments, the first material is impermeable to fluids, and forming the first wicking structure can include forming at least one flow channel defined by the first material. The at least one flow channel can be configured (e.g., sized and shaped) to pump a fluid (e.g., a two-phase working fluid) against a pressure differential in the heat pipe. In other embodiments, the first material can be a porous material defining one or more flow channels. Likewise, the second porous structure can also be configured to pump the fluid against the pressure differential in the heat pipe. The porous structure of the second wicking structure can have a finer porosity that allows for localized flow of the fluid against a greater pressure differential than the first wicking structure. Accordingly, the first and second wicking structures can together form a composite wicking structure.

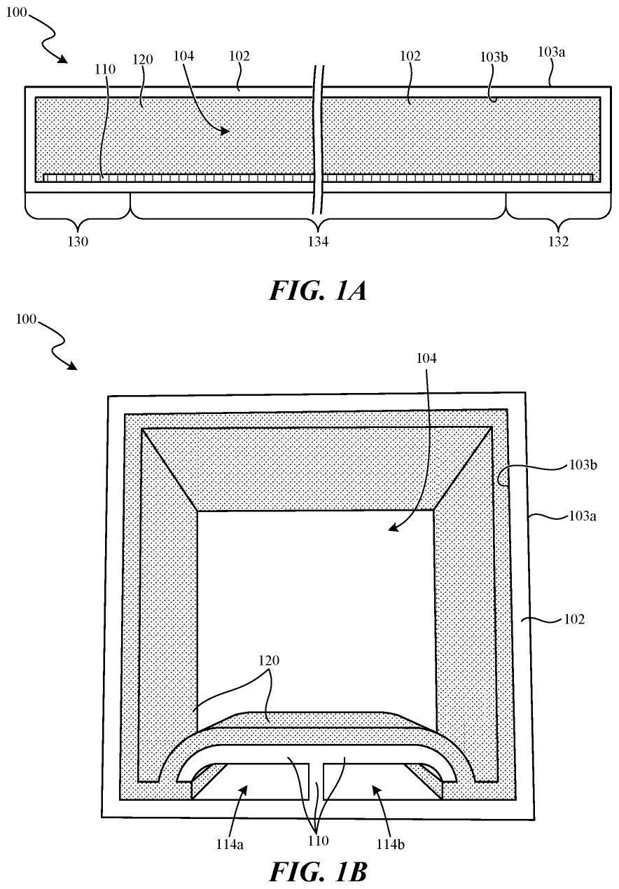

Certain details are set forth in the following description and in FIGS. 1-5 to provide a thorough understanding of various embodiments of the present technology. In other instances, well-known structures, materials, operations, and/or systems often associated with nuclear reactors, heat pipes, heat exchangers, additive manufacturing processes, and the like, are not shown or described in detail in the following disclosure to avoid unnecessarily obscuring the description of the various embodiments of the technology. Those of ordinary skill in the art will recognize, however, that the present technology can be practiced without one or more of the details set forth herein, and/or with other structures, methods, components, and so forth.

The terminology used below is to be interpreted in its broadest reasonable manner, even though it is being used in conjunction with a detailed description of certain examples of embodiments of the technology. Indeed, certain terms may even be emphasized below; however, any terminology intended to be interpreted in any restricted manner will be overtly and specifically defined as such in this Detailed Description section.

The accompanying Figures depict embodiments of the present technology and are not intended to limit its scope unless expressly indicated. The sizes of various depicted elements are not necessarily drawn to scale, and these various elements may be enlarged to improve legibility. Component details may be abstracted in the Figures to exclude details such as position of components and certain precise connections between such components when such details are unnecessary for a complete understanding of how to make and use the present technology. Many of the details, dimensions, angles and other features shown in the Figures are merely illustrative of particular embodiments of the disclosure. Accordingly, other embodiments can have other details, dimensions, angles and features without departing from the present technology. In addition, those of ordinary skill in the art will appreciate that further embodiments of the present technology can be practiced without several of the details described below.

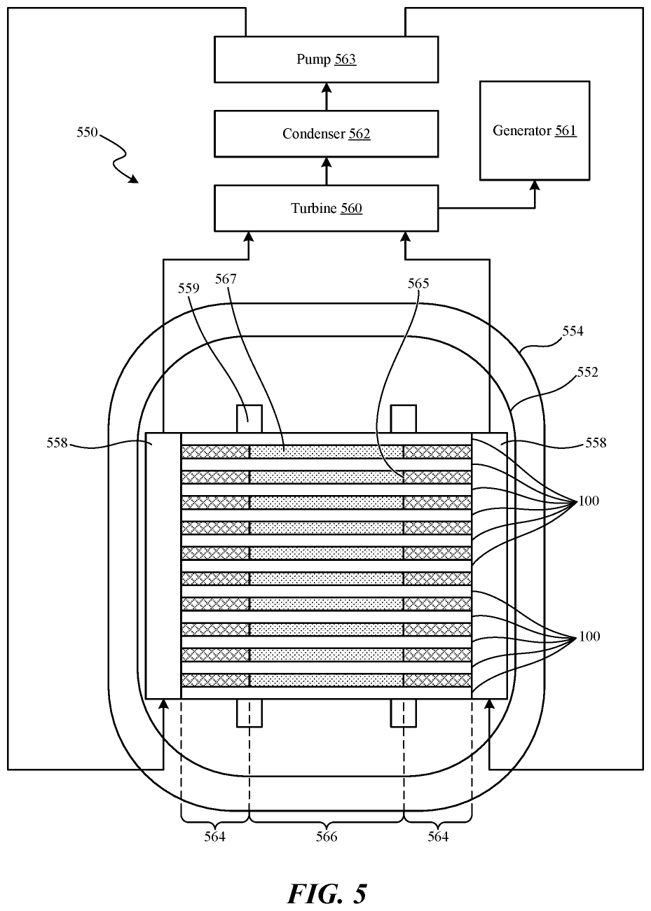

FIGS. 1A and 1B are a longitudinal cross-sectional view and a transverse cross-sectional isometric view, respectively, of a heat pipe 100 configured in accordance with embodiments of the present technology. Referring to FIGS. 1A and 1B together, the heat pipe 100 includes an outer wall or casing 102 having an outer surface 103a and an inner surface 103b, and defining a channel 104 (e.g., a cavity, a chamber). The heat pipe 100 includes a working fluid (not shown) that is contained within the channel 104. The working fluid can be a two-phase (e.g., liquid and vapor phase) material such as, for example, lithium, sodium, and/or potassium. The casing 102 can be formed from any suitably strong and thermally conductive material such as, for example, one or more metal or ceramic materials. In some embodiments, as described in further detail below with respect to FIG. 5, the heat pipe 100 can be used in a nuclear reactor system. In such embodiments, the casing 102 can be formed from suitably strong, thermally conductive, and neutron-resistant material. In some embodiments, the casing 102 can be formed of steel, molybdenum, molybdenum alloy, molybdenum-lanthanum oxide, and/or other metallic materials. In the illustrated embodiment, the casing 102 has a generally square cross-sectional shape while, in other embodiments, the casing 102 can have a circular, rectangular, polygonal, irregular, or other cross-sectional shape.

In the illustrated embodiment, the heat pipe 100 further includes a first wick 110 extending along/over a portion of the inner surface 103b, such as a lower/floor portion of the inner surface 103b (e.g., relative to gravity). The heat pipe 100 can further include a second wick 120 extending along/over all or a portion of the rest of the inner surface 103b and the first wick 110. In some embodiments, as shown in FIG. 1B, the first wick 110 can define one or more flow channels 114 (e.g., including an individually identified first flow channel 114a and a second flow channel 114b). The first and second wicks 110, 120 can also be referred to as porous structures, meshes, wicking structures, and the like.

Referring to FIG. 1A, the heat pipe 100 includes an evaporator region 130 at/near a first end thereof, a condenser region 132 at/near a second end thereof, and an adiabatic region 134 extending between the evaporator region 130 and the condenser region 132. The evaporator region 130 can be positioned to receive heat from a heat source such as, for example, a nuclear reactor system or an electronic system or component. In operation, the heat absorbed at the evaporator region 130 evaporates (e.g., vaporizes) the working fluid in the evaporator region and generates a pressure differential between the evaporator region 130 and the condenser region 132. The pressure differential drives the evaporated working fluid from the evaporator region 130, through the adiabatic region 134, and to the condenser region 132. The working fluid cools and condenses at the condenser region 132, thereby transferring heat to the casing 102 and out of the heat pipe 100. Referring again to FIGS. 1A and 1B together, the first and second wicks 110, 120 are configured to transport the condensed/cooled working fluid against the pressure gradient in the heat pipe 100 from the condenser region 132 to the evaporator region 130 where the working fluid can be heated and vaporized once again. Accordingly, in some embodiments heat is deposited into the evaporator region 130, removed from the condenser region 132, and neither removed from nor added in the adiabatic region 134.

In some embodiments, the first wick 110 is a coarse wick capable of relatively high throughput of the working fluid compared to the second wick 120. In some embodiments, the second wick 120 is a fine wick configured to pump the working fluid against a larger pressure gradient than the first wick 110, but for shorter distances than the first wick 110. Accordingly, the first and second wicks 110, 120 can together form a compound/composite wick in which (i) the first wick 110 allows for long distance flow of the working fluid and (ii) the second wick 120 allows for localized flow of the working fluid. In other embodiments, the heat pipe 100 can include other composite wick arrangements for promoting the flow of the working fluid through the channel 104 of the heat pipe 100.

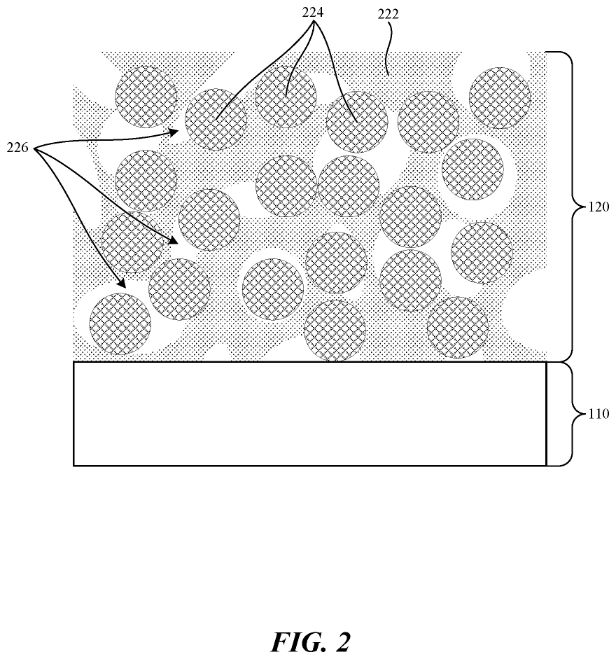

FIG. 2 is an enlarged cross-sectional view of an interface between a portion of the first wick 110 and a portion of the second wick 120 of the heat pipe 100 in accordance with embodiments of the present technology. In the illustrated embodiment, the first wick 110 is formed of a material that is relatively impermeable to fluids (e.g., the working fluid). With additional reference to FIGS. 1A and 1B, in some embodiments the first wick 110 can be formed of the same material as the casing 102 (e.g., steel, molybdenum, molybdenum alloy, molybdenum-lanthanum oxide, and/or other metallic materials) and/or can be integrally/monolithically formed together with the casing 102. In other embodiments, the first wick 110 can be formed of a porous material that can, for example, include/define a smaller hydraulic space than the second wick (e.g., the first wick 110 can be a coarse wick).

The second wick 120 can be formed from a mixture of materials including at least a first material 222 and a second material 224. The second material 224 can have higher melting temperature than the first material 222. In the illustrated embodiment, the second material 224 comprises a plurality of discrete particles that are bonded together by the first material 222 to form a porous structure or mesh including a plurality of pores 226 (e.g., openings, channels, pockets). In some embodiments, the first material 222 can form a thin film around the second material 224 (e.g., individual particles thereof) such that pores 226 define/fill a majority of the space within the second wick 120 between the particles of the second material 224. The pores 226 together provide a flow path for the working fluid through the second wick 120. In some embodiments, the first wick 110 and the second wick 120 can be integrally/monolithically formed together such that the first wick 110 and the second wick 120 together form a monolithic structure. In some embodiments, the first wick 110 and the second wick 120 can be formed of the same material (e.g., the second material 224) such that the first wick 110 and the second wick 120 provide an integral porous structure or mesh that provides a flow path for the working fluid,

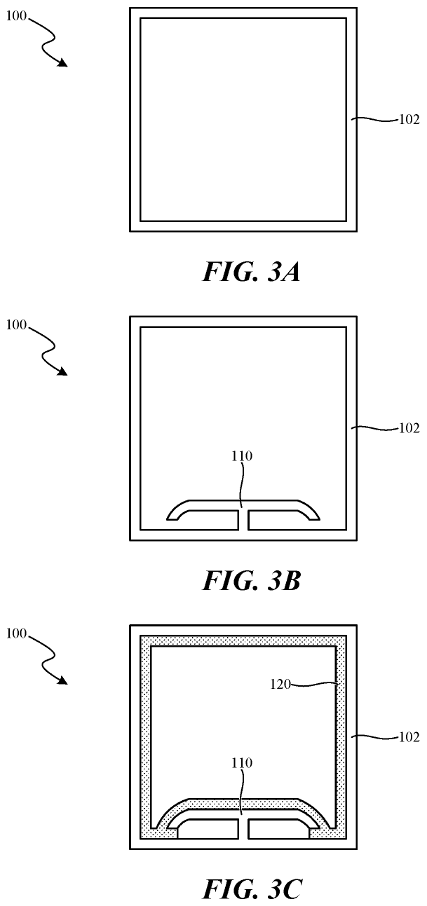

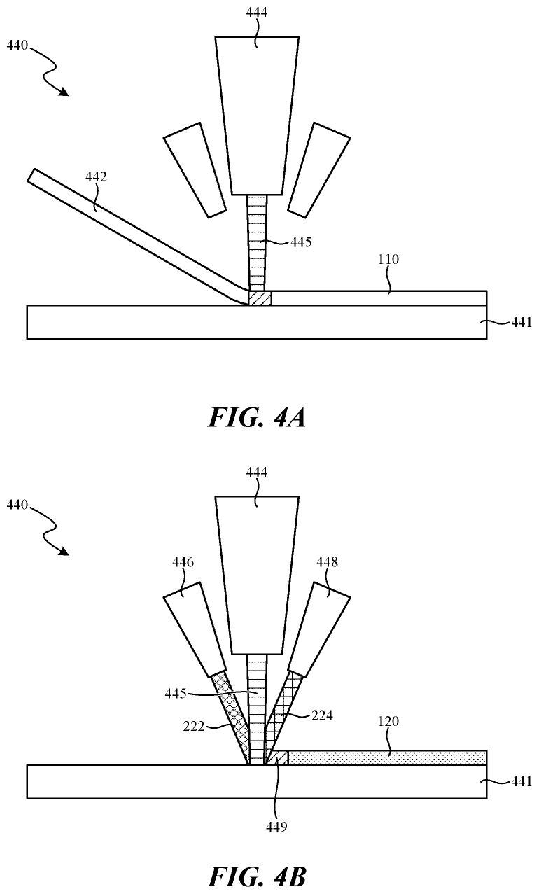

FIGS. 3A-3C are transverse cross-sectional views of the heat pipe 100 illustrating various stages in a method of manufacturing the heat pipe 100 in accordance with embodiments of the present technology. FIGS. 4A and 4B are cross-sectional side views of an additive manufacturing system 440 (“system 440”) that can be used in the method of manufacturing the heat pipe 100 shown in FIGS. 3A-3C in accordance with embodiments of the present technology. Although some features of the method of FIGS. 3A-3C are described in the context of the system 440 shown in FIGS. 4A and 4B for the sake of illustration, one skilled in the art will readily understand that the method can be carried out using other suitable systems and/or devices (e.g., other additive manufacturing systems and/or 3D printing systems).

FIG. 3A illustrates the heat pipe 100 after formation of the casing 102, and FIG. 3B illustrates the heat pipe 100 after formation of the first wick 110. In some embodiments, the casing 102 and the first wick 110 can be formed using the same manufacturing process and/or formed together to provide an integral/monolithic structure. With additional reference to FIG. 4A, for example, the system 440 can be a laser metal directed energy deposition (DED) system configured to melt a metallic material 442, such as a metal wire, to form the casing 102 and the first wick 110. In some embodiments, the system 440 can be used to form the casing 102 and the first wick 110 via a metal-wire-printing method. More specifically, the system 440 can include a laser source 444 configured to direct a laser 445 toward the metallic material 442, which can be positioned on a substrate 441. The substrate 441 can be a substrate separate from the heat pipe 100 or can be a previously-formed layer of the heat pipe 100 (e.g., a lower layer where the heat pipe 100 is additively manufactured in the longitudinal direction). The laser source 444 is configured to move relative to the substrate 441 and the metallic material 442 such that the laser 445 sequentially melts the metallic material 442 to form a weld pool 443 that subsequently cools and solidifies to form a portion of the casing 102 and the first wick 110. In some embodiments, the system 440 can be configured to supply a gas (e.g., an inert gas) toward the weld pool 443 to control various parameters of the manufacturing process.

FIG. 3C illustrates the heat pipe 100 after formation of the second wick 120. In some embodiments, the second wick 120 is directly formed on (e.g., printed on/over) the casing 102 and the first wick 110 such that the heat pipe 100 is an integral/monolithic structure. With additional reference to 4B, the system 440 can further include a first material source 446 (e.g., nozzle) configured to direct the first material 222 toward the laser 445 and a second material source 448 (e.g., nozzle) configured to direct the second material 224 toward the laser 445. Referring to FIGS. 2 and 4B together, the first material 222 can have a melting temperature selected such that the first material 222 melts when exposed to the laser 445, while the second material 224 can have a melting temperature selected such that the second material 224 does not melt when exposed to the laser 445. Accordingly, the first and second materials 222, 224 can be combined in a weld pool 449 including of a mixture of the melted first material 222 and discrete solid (e.g., not melted) particles of the second material 224. After heating, the weld pool 449 can subsequently cool and solidify to form a portion of the second wick 120. More specifically, the melted first material 222 can cool and solidify to bond the discrete solid (e.g., not melted) particles of the second material 224 together, thereby forming the porous second wick 120 including the pores 226.

In some embodiments, the first material 222 can be supplied from the first material source 446 as a powder, such as a powder of steel, molybdenum, and/or another metallic material. Similarly, the second material 224 can be supplied from the second material source 448 as a powder. In some embodiments, the second material 224 comprises a non-metallic material such as, for example, a ceramic material, graphite, zirconium carbide, titanium carbide, and/or other carbide material. Accordingly, in some aspects of the present technology the system 440 can supply the first and second materials 222, 224 as a mixture of two powders, one metallic and the other ceramic, such that the metallic powder melts when heated by the laser 445 and bonds the ceramic particles into the porous structure of the second wick 120. In other embodiments, the second material 224 can alternatively or additionally comprise a metallic material having a high enough melting temperature such that it does not melt when exposed to the laser 445 during manufacturing. Accordingly, in some aspects of the present technology the system 440 can supply the first and second materials 222, 224 as a mixture of two metallic powders such that only the metallic powder of the first material 222 melts when heated by the laser 445 to bond the metallic particles of the second material 224 into the porous structure of the second wick 120.

In other embodiments, the system 440 can supply the first and second materials 222, 224 in other manners. For example, the first and second materials 222, 224 can be supplied as separate powders via the same material source (e.g., nozzle). In some embodiments, instead of being supplied as separate powders or mixtures, the first material 222 can be pre-coated on the second material 224 such that the laser 445 melts the coat of the first material 222 off the second material 224 during manufacturing. Accordingly, in some aspects of the present technology the system 440 can supply the first and second materials 222, 224 as a non-metallic (e.g., ceramic) powder that is coated with a metal such that the metal melts when heated by the laser 445 to bond the non-metallic particles into the porous structure of the second wick 120.

With continued reference to FIGS. 2 and 4B together, melting the first material 222 to bond together discrete particles of the second material 224 can produce a very fine porous structure. In some aspects of the present technology, the fine porosity of the second wick 120 can allow the second wick 120 to pump the working fluid against a larger pressure gradient than porous structures having a coarser porosity. Notably, traditional manufacturing processes such as machining, casting, and the like are not able to produce the composite heat pipe 100 including the monolithically formed first and second wicks 110, 120 of different porosity.

In some embodiments, the heat pipe 100 described in detail with reference to FIGS. 1A-4B can be used to remove heat from a power plant system, such as a nuclear reactor system. In some embodiments, the heat pipe 100 can be used in any of the nuclear reactor systems described in detail in (i) U.S. patent application Ser. No. 17/071,838, titled “HEAT PIPE NETWORKS FOR HEAT REMOVAL, SUCH AS HEAT REMOVAL FROM NUCLEAR REACTORS, AND ASSOCIATED SYSTEMS AND METHODS,” and filed Oct. 15, 2020 and/or (ii) U.S. patent application Ser. No. 17/071,795, titled “NUCLEAR REACTORS HAVING LIQUID METAL ALLOY FUELS AND/OR MODERATORS,” filed Oct. 15, 2020, each of which is incorporated herein by reference in its entirety.

FIG. 5, for example, is a partially schematic side cross-sectional view of a nuclear reactor system 550 (“system 550”) including a plurality of the heat pipes 100 configured in accordance with embodiments of the present technology. In the illustrated embodiment, the system 550 includes a reactor container 552 and a radiation shield container 554 surrounding/enclosing the reactor container 552. In some embodiments, the reactor container 552 and the radiation shield container 554 can be roughly cylinder-shaped or capsule-shaped. The system 550 further includes a plurality of layers of the heat pipes 100 within the reactor container 552. Each of the layers can include one or more the heat pipes 100 (e.g., an array of the heat pipes 100). In the illustrated embodiment, the heat pipes 100 are spaced apart from and stacked over one another. In some embodiments, the heat pipes 100 can be mounted/secured to a common frame 559, a portion of the reactor container 552 (e.g., a wall thereof), and/or other suitable structures within the reactor container 552. In other embodiments, the heat pipes 100 can be directly stacked on top of one another such that each of the heat pipes 100 supports and/or is supported by one or more of the other ones of the heat pipes 100.

In the illustrated embodiment, the system 550 further includes a shield or reflector region 564 at least partially surrounding a core region 566. The heat pipes 100 can be circular, rectilinear, polygonal, and/or can have other shapes, such that the core region 566 has a corresponding three-dimensional shape (e.g., cylindrical, spherical). In some embodiments, the core region 566 is separated from the reflector region 564 by a core barrier 565, such as a metal wall. The core region 566 can include one or more fuel sources, such as fissile material, for heating the heat pipes 100. The reflector region 564 can include one or more materials configured to contain/reflect products generated by burning the fuel in the core region 566 during operation of the system 550. For example, the reflector region 564 can include a liquid or solid material configured to reflect neutrons and/or other fission products radially inward toward the core region 566. In some embodiments, the reflector region 564 can entirely surround the core region 566. In other embodiments, the reflector region 564 may only partially surround the core region 566. In some embodiments, the core region 566 can include a control material 567, such as a moderator and/or coolant. The control material 567 can at least partially surround the heat pipes 100 in the core region 566 and can transfer heat therebetween.

In the illustrated embodiment, the system 550 further includes at least one heat exchanger 558 positioned around the heat pipes 100. The heat pipes 100 can extend from the core region 566 and at least partially into the reflector region 564, and are thermally coupled to the heat exchanger 558. In some embodiments, the heat exchanger 558 can be positioned outside of or partially within the reflector region 564. The heat pipes 100 provide a heat transfer path from the core region 566 to the heat exchanger 558. During operation of the system 550, the fuel in the core region 566 can heat and vaporize the working fluid within the heat pipes 100 at the evaporator regions 130 (FIG. 1), and the fluid can carry the heat to the condenser regions 132 (FIG. 1) for exchange with the heat exchanger 558.

In some embodiments, the heat exchanger 558 can include one or more helically-coiled tubes that wrap around the heat pipes 100. The tubes of the heat exchanger 558 can include or carry a working fluid (e.g., a coolant such as water or another fluid) that carries the heat from the heat pipes 100 out of the reactor container 552 and the radiation shield container 554 for use in generating electricity, steam, and/or the like. For example, in the illustrated embodiment the heat exchanger 558 is operably coupled to a turbine 560, a generator 561, a condenser 562, and a pump 563. As the working fluid within the heat exchanger 558 increases in temperature, the working fluid may begin to boil and vaporize. The vaporized working fluid (e.g., steam) may be used to drive the turbine 560 to convert the thermal potential energy of the working fluid into electrical energy via the generator 561. The condenser 562 can condense the working fluid after it passes through the turbine 560, and the pump 563 can direct the working fluid back to the heat exchanger 558, where it can begin another thermal cycle.

Referring to FIGS. 1A-5 together, in some aspects of the present technology the heat pipes 100 can be manufactured to have very fine second wicks 120 using additive manufacturing processes. Such heat pipes can have improved thermal efficiencies that, for example, enable the heat pipes 100 to effectively convey heat from a nuclear reactor.

The following examples are illustrative of several embodiments of the present technology:

1. A method of manufacturing a heat pipe using a first material, a second material, and a third material, the method comprising:
forming a first wicking structure from the third material; and
forming a second wicking structure on the first wicking structure, wherein forming the second wicking structure includes—
   mixing the first material and the second material;
   heating the mixture of the first material and the second material to a temperature (a) less than a melting temperature of the first material and (b) greater than a melting temperature of the second material to melt the second material; and
   cooling the mixture of the first material and the second material to below the melting temperature of the second material such that the second material solidifies to bond together a plurality of particles of the first material into a porous structure.

2. The method of example 1 wherein the first wicking structure and the second wicking structure together form a monolithic structure.

3. The method of example 1 or example 2 wherein forming the first wicking structure includes forming the first wicking structure via a laser metal wire printing process.

4. The method of any one of examples 1-3 wherein mixing the first material and the second material includes mixing a powder of the first material, including the particles, and a powder of the second material.

5. The method of any one of examples 1-4 wherein mixing the first material and the second material includes mixing a powder, including the particles, wherein individual ones of the particles are coated with the second material.

6. The method of any one of examples 1-5 wherein the first material is a metallic material and the second material is a ceramic material.

7. The method of any one of examples 1-6 wherein the third material includes molybdenum, the first material includes molybdenum, and the second material includes a ceramic material.

8. The method of any one of examples 1-7 wherein the third material is impermeable to fluids, and wherein forming the first wicking structure includes forming at least one flow channel defined by the third material.

9. A method of forming a porous structure, comprising:
mixing a first material and a second material;
heating the mixture of the first material and the second material to a temperature (a) less than a melting temperature of the first material and (b) greater than a melting temperature of the second material to melt the second material; and
cooling the mixture of the first material and the second material to below the melting temperature of the second material such that the second material solidifies to bond together a plurality of particles of the first material into the porous structure.

10. The method of example 9 wherein the first material is a metallic material and the second material is a ceramic material.

11. The method of example 9 or example 10 wherein mixing the first material and the second material includes mixing a powder of the first material including the particles and a powder of the second material.

12. The method of any one of examples 9-11 wherein mixing the first material and the second material includes mixing a powder including the particles, wherein individual ones of the particles are coated with the second material.

13. The method of any one of examples 9-12 wherein heating the mixture of the first material and the second material includes directing a laser toward the mixture of the first material and the second material.

14. A porous structure, comprising:
a plurality of particles of a first material; and
a second material bonding together the particles of the first material, wherein the second material has a lower melting temperature than the first material.

15. The porous structure of example 14 wherein the first material is a non-metallic material.

16. The porous structure of example 14 or example 15 wherein the first material is a ceramic material.

17. The porous structure of any one of examples 14-16 wherein the first material is at least one of graphite, zirconium carbide, and titanium carbide.

18. The porous structure of any one of examples 14-17 wherein the first material is a non-metallic material and the second material is a metallic material.

19. The porous structure of any one of examples 14-18 wherein the first material is a ceramic material and wherein the second material is a metallic material.

20. The porous structure of any one examples 14-19 wherein the first material is a ceramic material and the second material is molybdenum.

The above detailed description of embodiments of the present technology are not intended to be exhaustive or to limit the technology to the precise forms disclosed above. Although specific embodiments of, and examples for, the technology are described above for illustrative purposes, various equivalent modifications are possible within the scope of the technology as those skilled in the relevant art will recognize. For example, although steps are presented in a given order, other embodiments may perform steps in a different order. The various embodiments described herein may also be combined to provide further embodiments.

From the foregoing, it will be appreciated that specific embodiments of the technology have been described herein for purposes of illustration, but well-known structures and functions have not been shown or described in detail to avoid unnecessarily obscuring the description of the embodiments of the technology. Where the context permits, singular or plural terms may also include the plural or singular term, respectively.

As used herein, the phrase “and/or” as in “A and/or B” refers to A alone, B alone, and A and B. To the extent any materials incorporated herein by reference conflict with the present disclosure, the present disclosure controls. Additionally, the term “comprising” is used throughout to mean including at least the recited feature(s) such that any greater number of the same feature and/or additional types of other features are not precluded. It will also be appreciated that specific embodiments have been described herein for purposes of illustration, but that various modifications may be made without deviating from the technology. Further, while advantages associated with some embodiments of the technology have been described in the context of those embodiments, other embodiments may also exhibit such advantages, and not all embodiments need necessarily exhibit such advantages to fall within the scope of the technology. Accordingly, the disclosure and associated technology can encompass other embodiments not expressly shown or described herein.

I/We claim:

1. A method of manufacturing a heat pipe using a first material, a second material, and a third material, the method comprising:
forming a first wicking structure from the third material; and
forming a second wicking structure on the first wicking structure, wherein forming the second wicking structure includes—
mixing the first material and the second material;
heating the mixture of the first material and the second material to a temperature (a) less than a melting temperature of the first material and (b) greater than a melting temperature of the second material to melt the second material; and
cooling the mixture of the first material and the second material to below the melting temperature of the second material such that the second material solidifies to bond together a plurality of particles of the first material into a porous structure.

2. The method of claim 1 wherein the first wicking structure and the second wicking structure together form a monolithic structure.

3. The method of claim 1 wherein forming the first wicking structure includes forming the first wicking structure via a laser metal wire printing process.

4. The method of claim 1 wherein mixing the first material and the second material includes mixing a powder of the first material, including the particles, and a powder of the second material.

5. The method of claim 1 wherein mixing the first material and the second material includes mixing a powder, including the particles, wherein individual ones of the particles are coated with the second material.

6. The method of claim 1 wherein the first material is a metallic material and the second material is a ceramic material.

7. The method of claim 1 wherein the third material includes molybdenum, the first material includes molybdenum, and the second material includes a ceramic material.

8. The method of claim 1 wherein the third material is impermeable to fluids, and wherein forming the first wicking structure includes forming at least one flow channel defined by the third material.

9. A method of forming a porous structure, comprising:
mixing a first material and a second material;
heating the mixture of the first material and the second material to a temperature (a) less than a melting temperature of the first material and (b) greater than a melting temperature of the second material to melt the second material; and
cooling the mixture of the first material and the second material to below the melting temperature of the second material such that the second material solidifies to bond together a plurality of particles of the first material into the porous structure.

10. The method of claim 9 wherein the first material is a metallic material and the second material is a ceramic material.

11. The method of claim 9 wherein mixing the first material and the second material includes mixing a powder of the first material including the particles and a powder of the second material.

12. The method of claim 9 wherein mixing the first material and the second material includes mixing a powder including the particles, wherein individual ones of the particles are coated with the second material.

13. The method of claim 9 wherein heating the mixture of the first material and the second material includes directing a laser toward the mixture of the first material and the second material.

14. A porous structure, comprising:
a plurality of particles of a first material; and
a second material bonding together the particles of the first material, wherein the second material has a lower melting temperature than the first material.

15. The porous structure of claim 14 wherein the first material is a non-metallic material.

16. The porous structure of claim 14 wherein the first material is a ceramic material.

17. The porous structure of claim 14 wherein the first material is at least one of graphite, zirconium carbide, and titanium carbide.

18. The porous structure of claim 14 wherein the first material is a non-metallic material and the second material is a metallic material.

19. The porous structure of claim 14 wherein the first material is a ceramic material and wherein the second material is a metallic material.

20. The porous structure of claim 14 wherein the first material is a ceramic material and the second material is molybdenum.
